(19) United States
(12) Patent Application Publication
(10) Pub. No.: US 2008/0173822 A1
(43) Pub. Date: Jul. 24, 2008

(54) Direct radiation converter module and direct radiation converter

(75) Inventors: Tobias Feltgen, Forchheim (DE); Peter Hackenschmied, Nuernberg (DE); Bjorn Heismann, Erlangen (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT

(21) Appl. No.: 11/905,253

(22) Filed: Sep. 28, 2007

(30) Foreign Application Priority Data
Sep. 29, 2006 (DE) 10 2006 046 314.5

(51) Int. Cl. G01T 1/24

(52) U.S. Cl. 250/370.01

(57) ABSTRACT

A direct radiation converter module and a direct radiation converter are disclosed. In at least one embodiment, the direct radiation converter module includes a direct converter layer, provided with a metal layer, for converting radiation absorbed therein into electrical charge. For protection and passivation, the surface, of the metal layer and of the direct conversion layer, is coated at least partially with a protective layer made from parylene.

### PRIORITY STATEMENT

The present application hereby claims priority under 35 U.S.C. §119 on German patent application number DE 10 2006 046 314.5 filed Sep. 29, 2006, the entire contents of which is hereby incorporated herein by reference.

### FIELD

Embodiments of the invention generally relate to a direct radiation converter module and/or to a direct radiation converter.

### BACKGROUND

A direct radiation converter module is known, for example, from EP 0415541 B1 and JP 09036410 A. In such direct converter modules, X- or gamma radiation is converted directly into electrical charge. Thus, the X- or gamma radiation is converted into electrical charges in a single interaction or conversion process. In order to protect the direct converter layer against mechanical damage, dirt, moisture and oxidation as well as to reduce leakage currents, it is necessary to passivate outer exposed surfaces of the direct converter layer. To this end, it is known from JP 09036410 A and U.S. Pat. No. 6,043,106 to provide a protective layer of silicon nitrite. It is furthermore known from U.S. Pat. No. 6,649,915 B2 to provide a protective layer based on ammonium fluoride.

A disadvantage of the known materials for producing the protective layer is that the methods required for applying the protective layer are relatively elaborate. Another disadvantage is that the quality of the protective layer depends on the topography of the surfaces to be coated. For example, it may happen that edges and cracks are not coated or sealed satisfactorily. The quality and protective properties of the layer are impaired by contractions and reduced layer thicknesses. This is detrimental to consistent long-term functionality and longevity of the direct radiation converter module.

### SUMMARY

In at least one embodiment of the invention, at least one of the disadvantages according to the prior art may be avoided. In at least one embodiment, a direct radiation converter module which includes a protective layer that can be applied in a particularly simple and material-friendly way. Furthermore, a direct radiation converter module is provided in at least one embodiment, including a protective layer which permits effective coating, essentially independent of the topography of the coated surfaces, in order to protect against dirt, moisture, foreign substances and degradation, in particular oxidation, as well as to reduce leakage currents along the surfaces.

According to one aspect of at least one embodiment of the invention, a protective layer made from parylene is applied at least partially on an outer surface of the metal layer and of the direct converter layer. The metal layer may be a back electrode applied onto the direct converter layer.

The protective layer provided in the direct radiation converter module can be applied in a particularly simple and material-friendly way. For example, it is possible to provide the protective layer at room temperature or at temperatures in the range of from 20 to 40 degrees Celsius. Outstanding protection against diffusion of foreign substances, for example dirt, moisture, alkali metals etc., into the direct converter module of the direct converter layer can be ensured by the protective layer according to at least one embodiment of the invention. At the same time, release of sometimes environmentally unfriendly, for example highly toxic, direct converter material from the direct converter layer can be avoided. It is furthermore possible to substantially reduce leakage currents along the surfaces, which impair optimal function of the direct radiation converter module. It is likewise possible to prevent the surface from being degraded, in particular oxidized, by external effects.

Another advantage of the protective layer according to at least one embodiment of the invention is that it is essentially independent of the topography of the direct radiation converter module, in particular of the direct converter layer and metal layer. A particularly uniform coating can therefore be achieved even on edges, cracks and gaps. Owing to the good adhesion properties and longevity of the protective layer, the function and reliability of the direct radiation converter module can be improved significantly.

The direct converter layer may be produced from any material with which the radiation can be converted into electrical charges in order to record it. Materials which may be envisaged are, for example: AlSb, CdS, CdTe, CdZnTe, GaAs, Ge, Se, etc.

According to one configuration, a plurality of electrodes, which are exposed relative to the protective layer and are peripherally enclosed by it, are provided on a contacting side lying opposite the radiation entry side in order to extract the electrical charge. With the protective layer made from parylene, it is possible to reliably coat and seal junctions between the electrodes and the direct converter layer, which generally include edges, grooves and cracks, so that the unexposed electrode region is firmly enclosed by the protective layer. Advantageously, the protective layer has a thickness which lies in the nanometer to micrometer range.

Another aspect of at least one embodiment of the invention provides a direct radiation converter having a plurality of direct radiation converter modules according to at least one embodiment of the invention. In respect of the advantages of the direct radiation converter, reference is made to the comments regarding the direct radiation converter module.

### BRIEF DESCRIPTION OF THE DRAWINGS

Configurations of embodiments of the invention will be described in more detail below with the aid of the drawings, in which:

FIG. 1 schematically shows a cross section through a direct radiation converter module according to an embodiment of the invention and

FIG. 2 shows a cross section through another direct radiation converter module according to an embodiment of the invention.

In the figures, references which are the same denote identical or functionally equivalent elements. For the sake of better comprehension, the figures are not necessarily true to scale.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described. Like numbers refer to like elements throughout. As used herein, the terms “and/or” and “at least one of” include any and all combinations of one or more of the associated listed items.

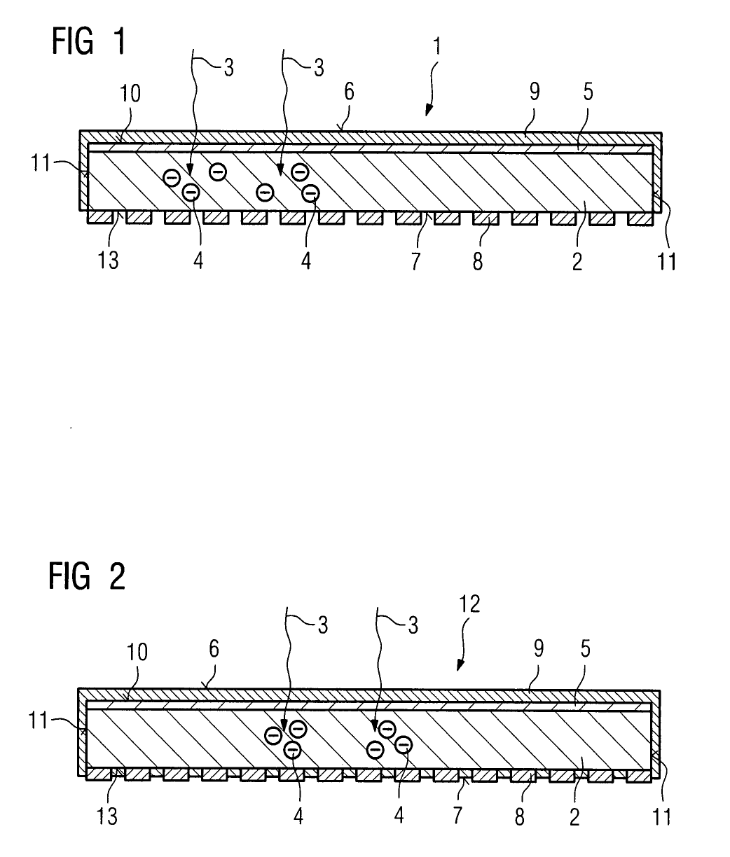

FIG. 1 shows a cross section through a direct radiation converter module 1 according to an embodiment of the invention. The direct radiation converter module 1 has a layer structure. The layer structure comprises a direct converter layer 2 made of a semiconductor material for converting radiation 3 absorbed therein into electrical charges 4, and a metal layer 5. The metal layer 5 is applied onto the direct converter layer 2 on a radiation entry side 6. A plurality of electrodes 8 for extracting the charges 4 are provided on a contacting side 7 of the direct converter layer 2, which lies opposite the radiation entry side 6. The metal layer 5 is a counter-electrode for the electrodes 8. An outer surface of the direct converter layer 2 and of the metal layer 5 is coated with a protective layer 9 produced on the basis of parylene. The outer surface includes a metal surface 10 of the metal layer 5, facing the radiation entry side, and, adjacent thereto, side surfaces 11 of the metal layer 5 and of the direct converter layer 2.

FIG. 2 shows a cross section of another direct radiation converter module 12. The further direct radiation converter module 12 has a similar layer structure with a direct converter layer 2 and a metal layer 5 applied thereon. Furthermore, the electrodes 8 are similarly provided on the contacting side 7 lying opposite the radiation entry side 6. Likewise, the protective layer is provided on the metal surface 10 and the side surfaces 11. Furthermore, and in contrast to FIG. 1, the protective layer 9 is also provided on surface regions 13 of the contacting side 7, which are formed between the electrodes.

The function of the direct radiation converter module 1 and of the further direct radiation converter module 12 is as follows:

The radiation 3 incident on the radiation entry side 6, which may in particular be X-, gamma or corpuscular radiation, passes through the protective layer 9 and the metal layer 5 and is absorbed by the direct converter material of the direct converter layer 2. The electrical charge 4, which can be extracted at the electrodes 8, is generated as a result of the absorption. Electrical signals generated in this way are delivered to a processing unit (not shown) and, for example, postprocessed to form a transmitted-radiation or X-ray image.

The function of the protective layer 9 is as follows:

A plurality of advantageous effects can be achieved by the protective layer 9. On the one hand it is possible to prevent leakage currents, which are detrimental to accurate recording of the charges 4, from being formed on the outer surface. In particular, it is possible to achieve good insulation between the electrodes 8. On the other hand, the surface can be sealed so that diffusion of foreign substances from the outside inward as well as of the direct converter material from the inside outward can be reliably avoided. It is possible to prevent ingress of moisture and other foreign substances and elements, which limit the lifetime of the direct converter layer 2 or are detrimental to its function. Furthermore, it is substantially possible to avoid releasing environmentally hazardous elements of the detector material, for example As, Cd, Ga, Te or Hg.

The protective layer 9 of parylene can be applied in a particularly material-friendly way, for example at temperatures in the range of 20 to 40 degrees Celsius. The effect achievable by this is that the quality of the direct converter layer 2 is not already crucially impaired during production. Owing to the material properties of parylene, it is possible to ensure that the protective layer has an essentially constant quality and thickness over the entire coated surface. Properties and qualities of the coating can therefore be prevented from varying with the topology of the surface. It is possible to ensure that essentially no layer thickness reduction takes place on edges to be coated, and that even gaps and cracks are sealed and covered reliably.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A direct radiation converter module for recording at least one of X-radiation and gamma radiation, comprising:
a direct converter layer for direct conversion of the at least one of X-radiation and gamma radiation into electrical charge, the direct converter layer being provided with a metal layer on a radiation entry side, a protective layer made from parylene being applied at least partially on an outer surface of the metal layer and at least partially on an outer surface of the direct converter layer.

2. The direct radiation converter module as claimed in claim 1, wherein the direct converter layer is produced on the basis of one of the following materials: AlSb, CdS, CdTe, CdZnTe, GaAs, Ge, and Se.

3. The direct radiation converter module as claimed in claim 1, wherein a plurality of electrodes, exposed relative to the protective layer and peripherally enclosed by the protective layer, are provided on a contacting side lying opposite the radiation entry side in order to extract the electrical charge.

4. The direct radiation converter module as claimed in claim 1, wherein the protective layer has a thickness which lies in the nanometer to micrometer range.

5. A direct radiation converter comprising a plurality of direct radiation converter modules as claimed in claim 1.

6. The direct radiation converter module as claimed in claim 1, wherein the direct converter layer includes at least one of AlSb, CdS, CdTe, CdZnTe, GaAs, Ge, and Se.

7. The direct radiation converter module as claimed in claim 2, wherein a plurality of electrodes, exposed relative to the protective layer and peripherally enclosed by the protective layer, are provided on a contacting side lying opposite the radiation entry side in order to extract the electrical charge.

8. The direct radiation converter module as claimed in claim 6, wherein a plurality of electrodes, exposed relative to the protective layer and peripherally enclosed by the protective layer, are provided on a contacting side lying opposite the radiation entry side in order to extract the electrical charge.

9. The direct radiation converter module as claimed in claim 2, wherein the protective layer has a thickness which lies in the nanometer to micrometer range.

10. The direct radiation converter module as claimed in claim 3, wherein the protective layer has a thickness which lies in the nanometer to micrometer range.

11. A direct radiation converter comprising a plurality of direct radiation converter modules as claimed in claim 2.

12. A direct radiation converter comprising a plurality of direct radiation converter modules as claimed in claim 3.

13. A direct radiation converter comprising a plurality of direct radiation converter modules as claimed in claim 4.
